(19) United States
(12) Patent Application Publication
(10) Pub. No.: US 2013/0081747 A1
(43) Pub. Date: Apr. 4, 2013

(54) USE OF COLORED INDICIA ON TIRES AS A DESIGNATOR

(71) Applicant: Bridgestone Americas Tire Operations, LLC, Nashville, TN (US)

(72) Inventors: Al SPEYER, Hendersonville, TN (US); Anton H. GEORGE, Indianapolis, IN (US); Francis John BYRNE, Franklin, TN (US); Keith SHRIEVE, Suffield, OH (US)

(73) Assignee: BRIDGESTONE AMERICAS TIRE OPERATIONS, LLC, Nashville, TN (US)

(21) Appl. No.: 13/622,458

(22) Filed: Sep. 19, 2012

Related U.S. Application Data
(63) Continuation of application No. 11/501,126, filed on Aug. 8, 2006, now abandoned.
Application No. 11/501,126 is a division of application No. 10/822,631, filed on Apr. 12, 2004, now abandoned.

(51) Int. Cl. B60C 1/00

(52) U.S. Cl. CPC B60C 1/001
USPC 152/525

(57) ABSTRACT

A method of providing race-specific information to an audience includes mounting a tire onto a vehicle entered in the race, the tire having information-bearing indicia provided on a black outer sidewall of the tire. The method further includes providing race-specific information to the audience by placing the vehicle in a stopped position on the track to expose the black outer sidewall of the tire to the audience, thereby permitting the audience to visibly detect the information-bearing indicia when the vehicle is stopped. The method also includes providing the same race-specific information to the audience by driving the vehicle along the track to expose the black outer sidewall of the tire to the audience thereby permitting the audience to visibly detect the information-bearing indicia on the black outer sidewall of the tire when the vehicle is moving.

### CROSS REFERENCE TO RELATED APPLICATIONS

This application is a continuation of U.S. application Ser. No. 11/501,126 filed on Aug. 8, 2006, which is a divisional of U.S. application Ser. No. 10/822,631 filed on Apr. 12, 2004, now abandoned. The disclosures of both applications are incorporated by reference herein in their entirety.

### BACKGROUND

For many years, tire manufacturers have placed indicia (i.e., letters, numerals, characters, symbols, trademarks or similar designations and descriptions) upon the sidewalls of tires for informational and identification purposes. For example, such indicia may take a variety of forms and convey information relative to the tire manufacturer, the brand name of the tire, the tire size, its construction and load limits, the quality grade thereof, sizes, mounting instructions, safety warnings, as well as the place and date of its manufacture.

Moreover, tires having decorative sidewalls, including color, are well known and can enhance the appearance and, thus, the marketability of the tires. For example, tires having a colored annular ring that extends around the sidewall of the tire (e.g., “white wall” tires) are known in the art and are used for decorative purposes.

### SUMMARY

A method of providing race-specific information to an audience includes mounting a tire onto a vehicle entered in the race, the tire having information-bearing indicia provided on a black outer sidewall of the tire. The method further includes providing race-specific information to the audience by placing the vehicle in a stopped position on the track to expose the black outer sidewall of the tire to the audience, thereby permitting the audience to visibly detect the information-bearing indicia when the vehicle is stopped. The method also includes providing the same race-specific information to the audience by driving the vehicle along the track to expose the black outer sidewall of the tire to the audience thereby permitting the audience to visibly detect the information-bearing indicia on the black outer sidewall of the tire when the vehicle is moving.

### BRIEF DESCRIPTION OF THE DRAWINGS

In the accompanying drawings which are incorporated in and constitute a part of the specification, embodiments of a mechanism and method are illustrated which, together with the detailed description given below, serve to describe example embodiments of the mechanism and method. It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1 illustrates an elevational view of a conventional tire 100.

FIG. 2 illustrates an elevational view of one embodiment of a pair of tires 200 configured to indicate right and left side installation on a racing vehicle.

FIG. 3 illustrates one embodiment of a methodology 300 associated with changing a tire during a vehicle race.

FIG. 4 illustrates an elevational view of one embodiment of a tire 400 configured to convey information to a racing audience.

FIG. 5 illustrates one embodiment of a methodology 500 associated with conveying race-related information to a racing audience during a race of vehicles.

### DETAILED DESCRIPTION

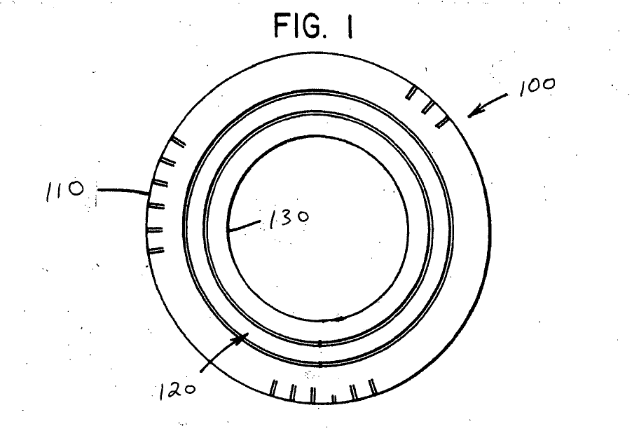

FIG. 1 illustrates an elevational view of a conventional tire 100. The tire 100 is provided with a tread area 110, an outer sidewall area 120, and an outer bead 130. By “outer,” it is understood to mean the side of the tire 100 that is visible when mounted upon a vehicle. It will be appreciated that all tires also have an inner sidewall (not shown) and an inner bead (not shown). The outer bead 130 defines an opening for receiving a wheel (not shown) and the outer sidewall 120 extends between and joins the tread area 110 and the outer bead 130.

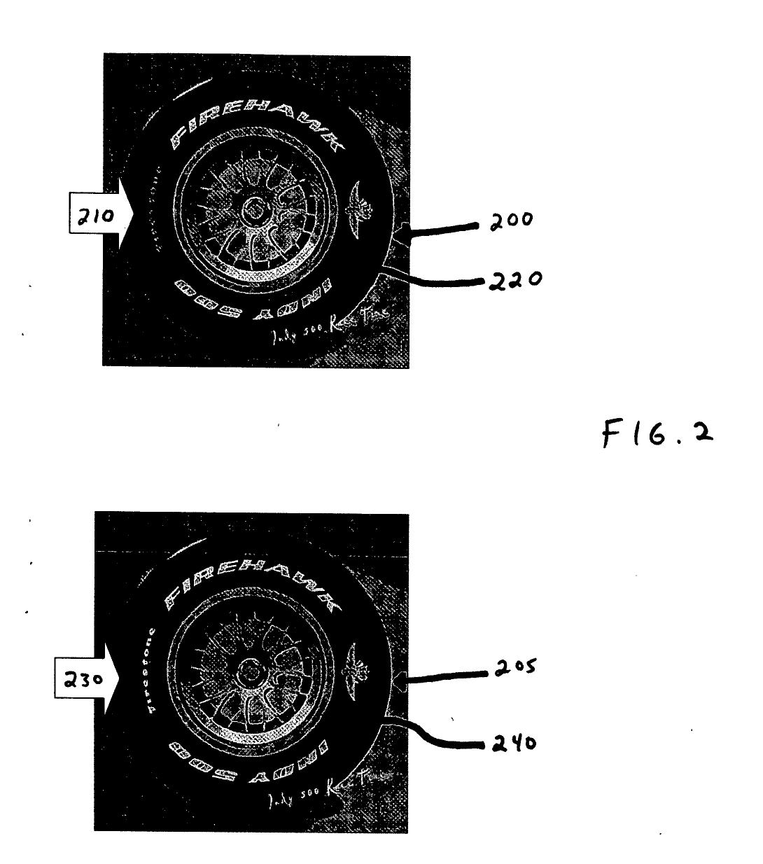

FIG. 2 illustrates an elevational view of one embodiment of a kit or pair of tires 200, 205 configured to indicate right and left side installation on a racing vehicle. In other words, the pair of tires 200, 205 can include indicia or markings provided thereon to indicate to a tire changer or other individual that one of the tires is to be mounted on a right side of the racing vehicle and the other tire is to be mounted on a left side of the racing vehicle. For example, as shown in FIG. 2, a first tire 200 can include first indicia 210 provided on an outer sidewall 220 of the first tire 200, while a second tire 205 can include second indicia 230 provided on an outer sidewall 240 of the second tire 205. Alternatively, the indicia or markings can be provided on a different portion of the tire (e.g., the tread area or the inner sidewall) or even the rim or wheel that supports the tire.

In one embodiment, the first and second indicia 210, 230 can include a high visibility marking such as a company name or logo as shown in FIG. 2. By “high visibility marking,” it is understood to mean that the markings are quickly identifiable and recognizable at a glance to permit a tire changer to confirm that a selected tire to be mounted on a certain side of the racing vehicle is the correct tire since time is of the essence for a tire change during a race. Accordingly, the high visibility markings should be sufficiently large enough to permit such a quick visual confirmation. Other than company names or logos, it will be appreciated that the first and second indicia 210, 230 can include letters, numerals, characters, shapes, ornamental designs, decorative patterns, trademarks, or any combination thereof.

To indicate right and left side installation, the first and second indicia 210, 230 on the tires 200, 205, respectfully, can differ in color. For example, the color of the first indicia 210 can be “red” to designate right side installation and the color of the second indicia 230 can be “white” to designate left side installation. Obviously, the first and second indicia 210, 230 can be any two different colors so long as there is a visible difference between the two colors. By providing a high visibility marking on the tires 200, 205, the tire changer can quickly check and confirm that the tires 200, 205 are being applied to the racing vehicle correctly. It will be appreciated that the colors of the first and second indicia 210, 230 should be sufficiently different than the color of the sidewalls of the tires 200, 205 to provide a visual contrast between the indicia and the sidewalls. It will also be appreciated that the first and second indicia 210, 230 on the tires 200, 205 can be the same color, but differ in size to indicate right and left side installation.

In an alternative embodiment, the first and second indicia 210, 230 on the first and second tires 200, 205, respectively, can include different letters, numerals, characters, shapes, ornamental designs, decorative patterns, or trademarks to indicate right and left side installation. For example, the first indicia 210 provided on the first tire 200 can include one set of letters (e.g., the word “RIGHT”), while the second indicia provided on the second tire 205 can include a different set of letters (e.g., the word “LEFT”). In another embodiment, the first and second indicia 210, 230 on the tires 200, 205, respectively, can include one or more spaced-apart arcuate segments or stripes that extend around at least a portion of the circumference of the outer sidewalls 220, 240 of the tires 200, 205, respectively, that differ in thickness to indicate right and left side installation. For example, a thicker segment or stripe can indicate right side installation, while a thinner segment or stripe can indicate left side installation.

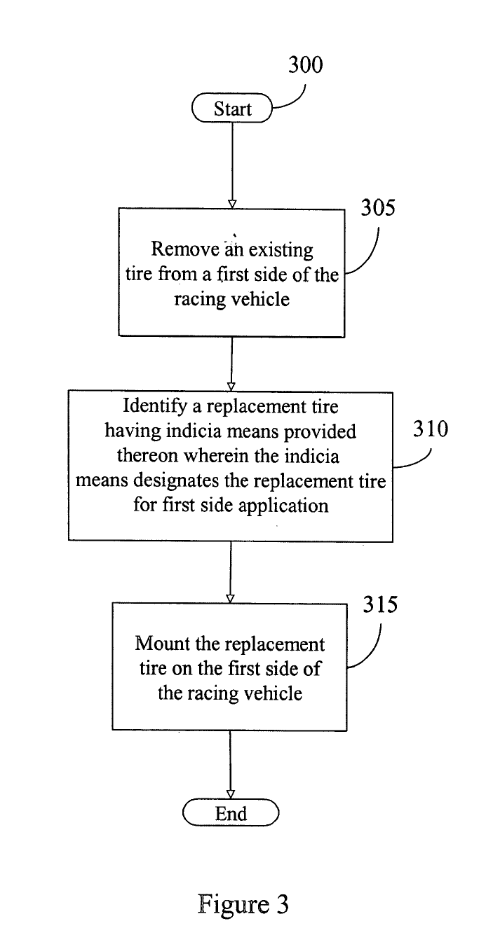

Illustrated in FIG. 3 is one embodiment of a methodology associated with changing a tire during a vehicle race. The illustrated elements denote “processing blocks” and represent functions and/or actions taken for changing a tire during the vehicle race. It will be appreciated that the methodology may involve dynamic and flexible processes such that the illustrated blocks can be performed in other sequences different than the one shown and/or blocks may be combined or, separated into multiple components. The foregoing applies to all methodologies described herein.

With reference to FIG. 3, the process 300 involves a tire changing process. The tire changing process can be accomplished by an individual or group of individuals (e.g., one or more tire changers in a pit crew). The process 300 can include removing an existing tire from a first side of the racing vehicle (block 305). A replacement tire, having indicia disposed thereon that indicates the replacement tire is to be mounted on the first side of the racing vehicle, can then be identified (block 310). Finally, the replacement tire can be mounted onto the first side of the racing vehicle (block 315).

Optionally, the process 300 can further include changing a tire from a second side of the racing vehicle. For example, the process can include removing an existing tire from a second side of the racing vehicle. A replacement tire, having indicia disposed thereon that indicates that the replacement tire is to be mounted on the second side of the racing vehicle, can then be identified. Finally, the replacement tire can be mounted onto the second side of the racing vehicle.

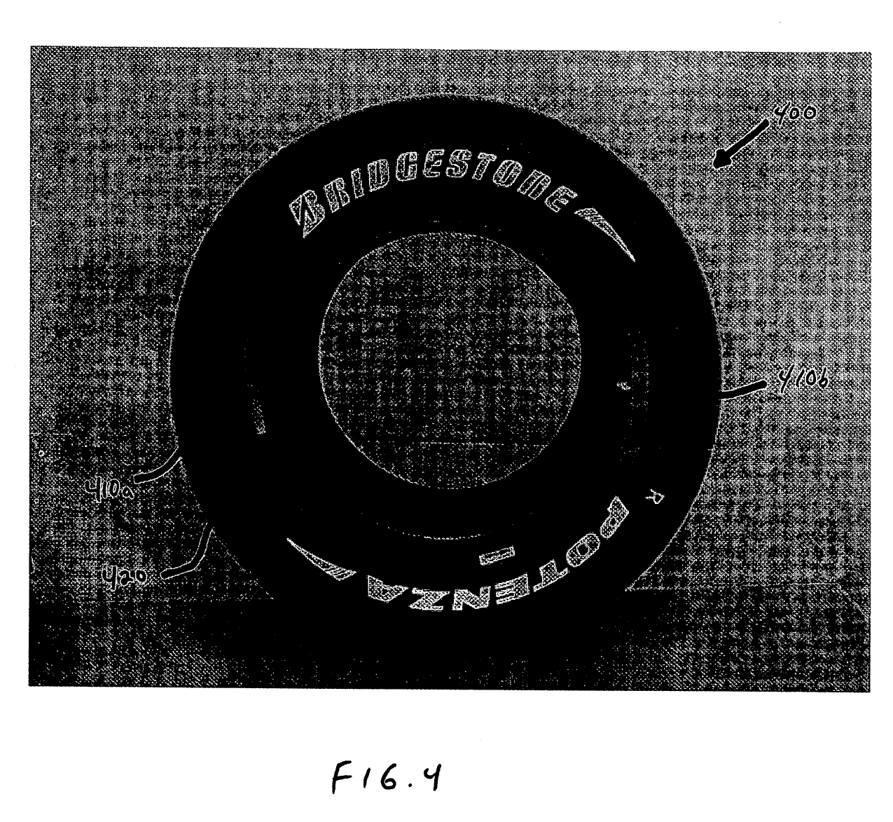

FIG. 4 illustrates an elevational view of one embodiment of a tire 400 configured to convey information to a racing audience (e.g., the in-person spectators and/or the television audience). In other words, the tire 400 can include colored indicia or markings that the racing audience can visibly detect to provide the audience with race-related information. For example, the tire 400 can include colored indicia 410 provided on an outer sidewall 420 of the tire 400.

In one embodiment, the colored indicia 410 can be two spaced-apart arcuate segments or stripes 410a, 410b. As shown in FIG. 4, the arcuate segments 410a, 410b can extend around at least a portion of the circumference of the outer sidewall 420. It will be appreciated that the colored indicia 410 can include one or more than two spaced-apart arcuate segments extending around the circumference of the tire 400. Optionally, the colored indicia 410 can be a solid annular ring that extends around the entire circumference of the tire 400. Although spaced-apart arcuate segments 410a, 410b are illustrated in FIG. 4, it will also be appreciated that the colored indicia 410 can be letters, numerals, characters, shapes, ornamental designs, decorative patterns, trademarks, logos, or any combination thereof.

In one embodiment, the color of the colored indicia 410 can be “red.” However, it will be appreciated that the colored indicia 410 can be any color other than “red” so long as there is a sufficient visible contrast between the colored indicia 410 and the outer sidewall 420 of the tire 400 to enable the racing audience to visibly detect the colored indicia from a distance while the tire 400 is rotating during the race. It will be appreciated that the two red spaced-apart arcuate segments 410a, 410b will resemble a red ring as viewed by the racing audience when the tire 400 is rotating during the race.

In one embodiment, the colored indicia 410 on the tire 400 can indicate to the racing audience that the tire 400 mounted on the racing vehicle is constructed of a particular rubber compound. For example, before a racing event, racing promoters can inform the prospective racing audience that a “special” type of tire may be used during the race. The “special” type of tire may be constructed of a different rubber compound than the regular tires (e.g., a softer rubber compound to improve grip). The racing promoters can inform the prospective racing audience that the “special” tires will have colored indicia on the outer sidewall designating the tires as “special.” Thus, when the racing audience visibly detects the racing vehicles with the colored indicia on its tires during the race, the racing audience will know that the racing vehicle is using the “special” tires. It will be appreciated that the colored indicia can convey other information to the racing audience about the type of tire used on the racing vehicle (e.g., hard compound tire, rain tire, tread pattern, etc.).

In another embodiment, the colored indicia 410 on the tire 400 can indicate to the racing audience that the driver of the racing vehicle having these tires 400 mounted thereon is a points leader of a vehicle racing series or has the pole position for a certain vehicle race. For example, before each race, the prospective racing audience can be informed that the vehicle in the race having certain colored indicia provided on its tires is the points leader of the vehicle racing series or the pole position holder of that particular racing event. Thus, when the racing audience visibly detects the racing vehicle having the colored indicia on its tires during the race, the racing audience will know that the driver of the racing vehicle is the points leader for the racing series and/or the pole position holder of the race.

It will be appreciated that the colored indicia 410 provided on the tire 400 can also convey information to the pit crew. For example, if one of the regulations of a race requires that a set of the “special” tires be used at least once during the race, the pit crew can quickly confirm that the “special” tires were used during the race through the visible detection of the colored indicia on the tires.

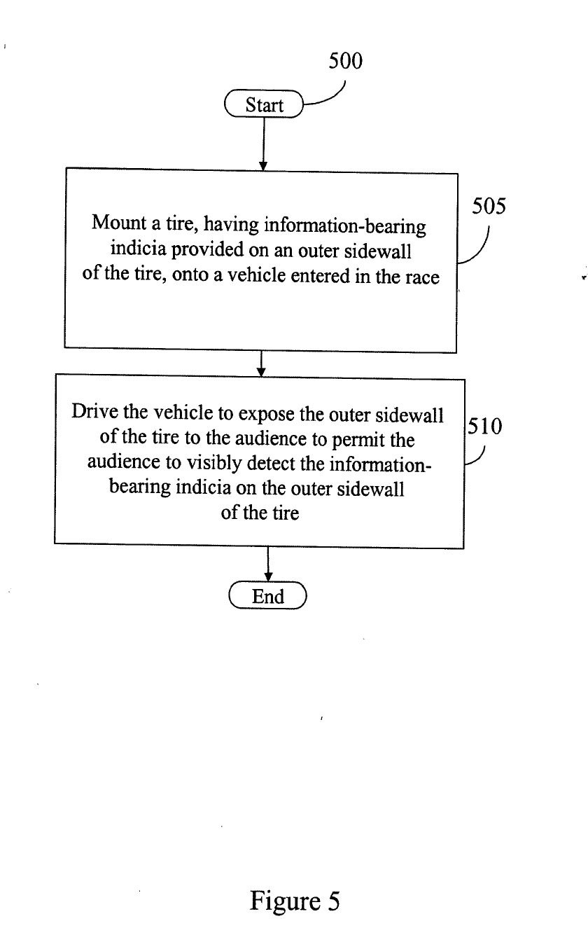

Illustrated in FIG. 5 is one embodiment of a methodology associated with conveying race-related information to a racing audience during a race of vehicles along a track. The process 500 can include mounting a tire onto a vehicle entered in the race wherein the tire has information-bearing indicia provided on an outer sidewall of the tire (block 505). The vehicle can then be driven along the track to expose the outer sidewall of the tire to the racing audience thereby permitting the audience to visibly detect the information-bearing indicia on the outer sidewall of the tire (block 510).

The indicia and markings described above can be applied to the tires utilizing any of a variety of existing technologies. Suitable technologies to apply indicia or markings to a sidewall of a tire after cure include, but are not limited to: 1) thermal transfer or lamination processes such as the process described in U.S. Pat. No. 5,047,110, which is hereby incorporated by reference in its entirety herein; 2) adhesive bonding processes where a decal is affixed to the sidewall of a tire with an adhesive such as the process described in U.S. Pat. No. 5,300,164, which is hereby incorporated by reference in its entirety herein; 3) ink jet printing technologies; and 4) other printing and/or painting processes. Although the indicia or markings can be applied before or after cure of the tire, an advantage in applying the indicia or markings to the tires after cure is that the tire manufacturer is free to make essentially one group of master tires and then apply different indicia or markings to them.

In an alternative embodiment, the rims or wheels of the racing vehicle may include colored indicia to indicate the points leader of a vehicle racing series or the pole position holder. In one embodiment, the rims of the racing vehicle may be a different color than the rims of the rest of the racing field to indicate the points leader of a vehicle racing series and/or the pole position holder. For example, the points leader and/or pole position holder can have gold wheels while the rest of the racing field has black or silver wheels.

The colored indicia described above can be applied to the rims utilizing any of a variety of existing technologies. Suitable technologies to apply colored indicia to a rim include, but are not limited to: 1) plating processes to plate the entire rim or a portion thereof (e.g., chrome plating, gold plating, etc.); 2) painting processes to paint the entire rim or a portion thereof; 3) inkjet processes or other printing processes to print colored indicia on the rim; and 4) adhesive bonding processes where a decal can be affixed to the rim.

In one embodiment, the indicia or markings described above can be substantially permanent such that they are designed to last the duration of the race. However, it will be appreciated that the markings on the tires or rims indicating left or right installation may not need to be substantially permanent as they are likely more useful prior to and/or during the mounting of the tires onto the racing vehicle.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A method of providing race-specific information to an audience during a race of vehicles along a track, the method comprising:
mounting a tire onto a vehicle entered in the race, the tire having information-bearing indicia provided on a black outer sidewall of the tire;
providing race-specific information to the audience by placing the vehicle in a stopped position on the track to expose the black outer sidewall of the tire to the audience, thereby permitting the audience to visibly detect the information-bearing indicia when the vehicle is stopped; and
providing the same race-specific information to the audience by driving the vehicle along the track to expose the black outer sidewall of the tire to the audience thereby permitting the audience to visibly detect the information-bearing indicia on the black outer sidewall of the tire when the vehicle is moving,
wherein the race specific information is the softness of a rubber compound of the tire.

2. The method of claim 1, wherein the information-bearing indicia is a colored stripe that extends around at least a portion of a circumference of the black outer sidewall of the tire.

3. The method of claim 2, wherein the information-bearing indicia designates a type of rubber compound used to construct the tire.

4. The method of claim 3, wherein the audience includes a television audience.

5. The method of claim 1, wherein the information-bearing indicia includes letters.

6. The method of claim 5, wherein the information-bearing indicia designates a type of rubber compound used to construct the tire.

7. The method of claim 6, wherein the audience includes a television audience.

8. The method of claim 1, wherein the information-bearing indicia designates a type of rubber compound used to construct the tire.

9. The method of claim 8, wherein the audience includes a television audience.

10. The method of claim 1, wherein the audience includes a television audience.
